(19) United States
(12) Patent Application Publication
(10) Pub. No.: US 2019/0124629 A1
(43) Pub. Date: Apr. 25, 2019

(54) RADIO BASE STATION AND COMMUNICATION CONTROL METHOD

(71) Applicant: NTT DOCOMO, INC., Tokyo (JP)

(72) Inventors: Tooru Uchino, Tokyo (JP); Anil Umesh, Tokyo (JP); Naoto Ookubo, Tokyo (JP)

(73) Assignee: NTT DOCOMO, INC., Tokyo (JP)

(21) Appl. No.: 16/091,898

(22) PCT Filed: Feb. 13, 2017
(86) PCT No.: PCT/JP2017/005101

§ 371 Date: Oct. 5, 2018

(30) Foreign Application Priority Data
Apr. 8, 2016 (JP) 2016-078455

(51) Int. Cl. H04W 72/04; H04W 72/12

(52) U.S. Cl. CPC H04W 72/042; H04W 72/12

(57) ABSTRACT

One object is to provide a radio base station and a communication control method in which a remote device can correctly transmit downlink data based on radio resource assignment information from a central aggregation device even when a function of an upper layer such as MAC scheduler and a function of a radio physical layer are mounted separately. The method includes transmitting including a central aggregation device (210) of a radio base station transmitting to a remote device (260) a frame containing each of assignment information indicating radio resource assignment and downlink data that is data transmitted to a user device (300), and transmitting including the remote device (260), based on the received frame, transmitting the assignment information to the user device (300) via PDCCH and transmitting the downlink data to the user device (300) via DLSCH. The central aggregation device (210) transmits a frame having a configuration indicating a correspondence between the assignment information and the downlink data.

### TECHNICAL FIELD

The present invention relates to a radio base station including a remote device and a central aggregation device and that performs radio communication with a user device, and to a communication control method.

### BACKGROUND ART

3rd Generation Partnership Project (3GPP) specifies, with the aim of further speeding Long Term Evolution (LTE), LTE-Advanced (hereinbelow, the LTE includes the LTE-Advanced). Moreover, in the 3GPP, specification of succeeding systems of the LTE called 5G (5th generation mobile communication system) and the like is being considered.

So-called C-RAN radio base station including a central aggregation device having a scheduler function (MAC scheduler) and the like in MAC layer, and a remote device arranged at a remote installation site from the central aggregation device is used in the LTE. The remote device includes a radio unit (RF unit) such as PA (Power Amplifier)/LNA (Low Noise Amplifier), a radio transmission—reception module, and a modulation—demodulation module.

The central aggregation device and the remote device are connected to each other by a wired transmission path called a front-haul. For example, Common Public Radio Interface (CPRI) is known as an interface between the central aggregation device and the remote device.

On the occasion of consideration of the specification of the 5G, it is proposed (for example, see Non-Patent Document 1) to mount the function of a radio physical layer (layer 1) in the remote device that used to be mounted in the central aggregation device until now. When the function of the radio physical layer is mounted in the remote device, required transmission band for the front-haul can be reduced.

### PRIOR ART DOCUMENT

### Non-Patent Document

[Non-Patent Document 1]: 3GPP RWS-150051 (3GPP RAN workshop on 5G), “5G Vision for 2020 and Beyond,” 3GPP, September, 2015

### SUMMARY OF THE INVENTION

As mentioned above, the following issues arise when the function of the radio physical layer, which used to be mounted in the central aggregation device until now, is mounted in the remote device. That is, the function of an upper layer (layer 2, and the like) such as the MAC scheduler is mounted in the central aggregation device in the same manner as before.

Therefore, for example, it is necessary for the central aggregation device to sequentially transmit to a remote device downlink data such as radio resource assignment information transmitted via a downlink control channel (PDCCH: Physical Downlink Control Channel) and user data that is transmitted to a user device (called radio communication terminal or mobile station) via a downlink shared channel (DLSCH: Downlink Shared Channel).

However, when the central aggregation device simply transmits the assignment information and the downlink data to the remote device, the remote device cannot identify which radio resource assignment information to use for transmitting the downlink data. Therefore, the remote device cannot correctly transmit the downlink data to the user device.

The present invention has been made in view of the above discussion. One object of the present invention is to provide a radio base station and a communication control method in which a remote device can correctly transmit downlink data based on radio resource assignment information from a central aggregation device even when a function of an upper layer such as the MAC scheduler and a function of a radio physical layer are mounted separately.

A radio base station according to one aspect of the present invention includes a remote device and a central aggregation device and performs radio communication with a user device. The central aggregation device includes a frame transmitting unit that transmits to the remote device a frame containing each of assignment information indicating radio resource assignment and downlink data that is data transmitted to the user device, and the remote device includes a frame receiving unit that receives the frame; and a channel transmitting unit that, based on the frame received by the frame receiving unit, transmits the assignment information to the user device via a downlink control channel and transmits the downlink data to the user device via a downlink shared channel, wherein the frame transmitting unit transmits the frame having a configuration indicating a correspondence between the assignment information and the downlink data, and the channel transmitting unit sets the downlink control channel and the downlink shared channel based on the correspondence.

A communication control method according to another aspect of the present invention is implemented in a radio base station including a remote device and a central aggregation device and that performs radio communication with a user device. The communication control method includes transmitting including the central aggregation device transmitting to the remote device a frame containing each of assignment information indicating radio resource assignment and downlink data that is data transmitted to the user device; and transmitting including the remote device, based on the received frame, transmitting the assignment information to the user device via a downlink control channel and transmitting the downlink data to the user device via a downlink shared channel, wherein the transmitting the frame to the remote device includes transmitting the frame having a configuration indicating a correspondence between the assignment information and the downlink data, and the transmitting the downlink data to the user device includes setting the downlink control channel and the downlink shared channel based on the correspondence.

### BRIEF DESCRIPTION OF DRAWINGS

FIG. 1 is an overall structural diagram of a radio communication system 10.

FIG. 2 is an overall block diagram of the radio communication system 10.

FIG. 3 is a functional block diagram of a central aggregation device 210.

FIG. 4 is a functional block diagram of a remote device 260.

FIG. 5 is a conceptual diagram of a transmission operation of a downlink control channel (PDCCH) and a downlink shared channel (PDSCH) performed by the central aggregation device 210, the remote device 260, and a user device 300.

FIG. 6 depicts a channel transmission sequence based on a frame transmitted from the central aggregation device 210.

FIG. 7 is a configuration example (1) of the frame.

FIG. 8 is a configuration example (2) of the frame.

FIG. 9 is a configuration example (3) of the frame.

### MODES FOR CARRYING OUT THE INVENTION

Exemplary embodiments are explained below with reference to the accompanying drawings. In the drawings, structural elements having the same function or configuration are indicated by the same or similar reference numerals and the explanation thereof is appropriately omitted.

(1) Overall Structural Configuration of Radio Communication System

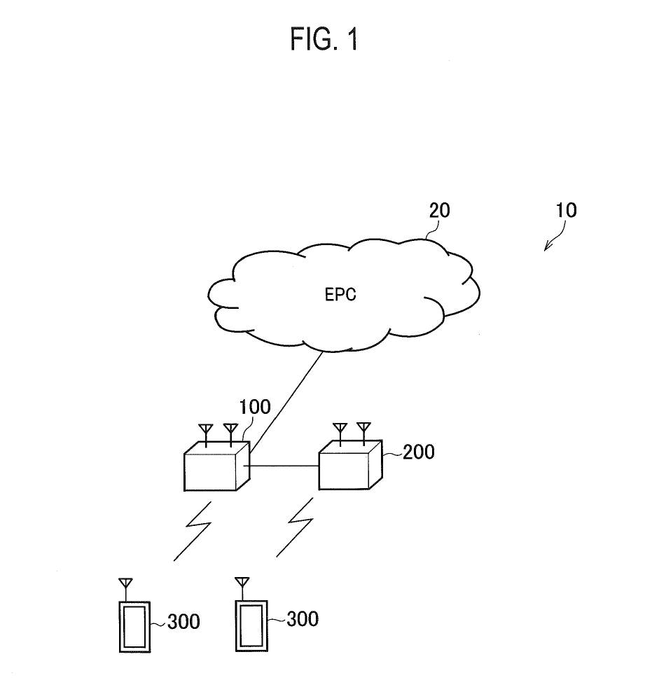

FIG. 1 is an overall structural diagram of a radio communication system 10 according to the present embodiment. The radio communication system 10 is a radio communication system in accordance with Long Term Evolution (LTE), and 5G which is a succeeding system of the LTE.

In the present embodiment, the LTE (including LTE-Advanced) will be appropriately called “4G” to show the correspondence thereof with the 5G. Moreover, in the present embodiment, a radio communication system having a configuration that is right after the 5G was introduced is assumed, and LTE assisted operation in which the 5G assists the 4G is realized.

The radio communication system 10 includes a core network 20, a radio base station 100, a radio base station 200, and one or more user devices 300.

The core network 20 is also called Evolved Packet Core (EPC) and is constituted by a mobility management entity (MME), a serving gateway (S-GW), PDN gateway (P-GW), and the like.

The radio base station 100 is a radio base station in accordance with the 4G and is also called eNodeB. The radio base station 100 is connected to a device (node) constituting the core network 20 via S1-MME or S1-U interface.

The radio base station 200 is a radio base station in accordance with the 5G. The radio base station 200 is connected to the radio base station 100 via X2 interface (below conveniently refers to as X2-AP′, X2-U′).

The user device 300 (UE) can perform radio communication with the radio base station 100 and the radio base station 200. The user device 300 may be called a radio communication terminal or a mobile station. The radio base station 200 and the user device 300 can be caused to support, by controlling a radio signal transmitted by a plurality of antenna elements, Massive MIMO that generates a beam having higher directivity, carrier aggregation (CA) that uses a plurality of component carriers (CC), dual connectivity (DC) in which a component carrier is transmitted at the same time between a plurality of radio base stations and the user device 300, and the like.

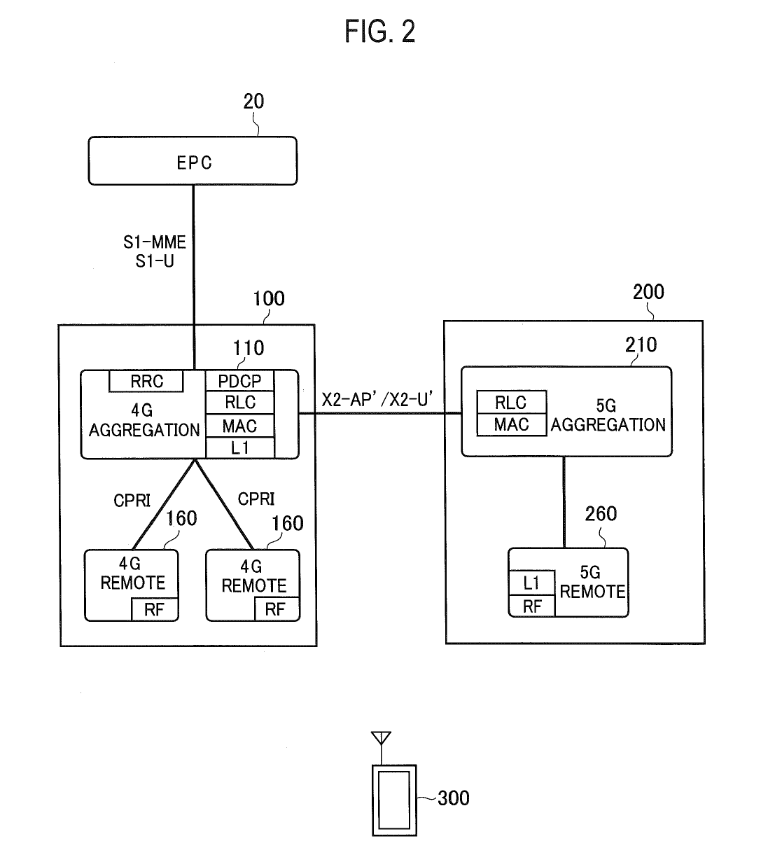

FIG. 2 is an overall block diagram of the radio communication system 10. As shown in FIG. 2, the radio base station 100 includes a central aggregation device 110 and one or more remote devices 160. The radio base station 200 includes a central aggregation device 210 and a remote device 260. It is allowable that each of the radio base station 100 and the radio base station 200 includes some device other than the central aggregation device and the remote device.

The central aggregation device 110 includes a radio physical layer (L1), a medium access control layer (MAC), a radio link control layer (RLC), and a packet data convergence protocol layer (PDCP). Moreover, the central aggregation device 110 includes a radio resource control layer (RRC) as an upper layer of the PDCP.

The remote device 160 can be installed at a site that is remote from the central aggregation device 110. The remote device 160 includes a radio unit (RF unit) such as the PA (Power Amplifier)/LNA (Low Noise Amplifier), a radio transmission-reception module, and a modulation-demodulation module.

The central aggregation device 110 is also called a digital processing unit (Digital Unit (DU)) or Central Unit (CU), and the remote device 160 is also called a radio processing unit (Radio Unit (RU)) or Remote Unit (RU). The central aggregation device 110 and the remote device 160 are connected to each other via a wired transmission path called a front-haul. For example, the Common Public Radio Interface (CPRI) is used as an interface between the central aggregation device 110 and the remote device 160.

Although the central aggregation device 210 and the remote device 260 respectively correspond to the central aggregation device 110 and the remote device 160, the layer configurations thereof are different.

Specifically, the central aggregation device 210 includes the medium access control layer (MAC) and the radio link control layer (RLC). The remote device 260 includes the radio physical layer (L1) and the radio unit (RF).

As described above, the central aggregation device 210 is connected to the central aggregation device 110 via X2-AP′, X2-U′ interface.

(2) Functional Block Configuration of Radio Communication System

A functional block configuration of the radio communication system 10 is explained below. Specifically, functional block configurations of the central aggregation device 210 and the remote device 260 are explained.

(2.1) Central Aggregation Device 210

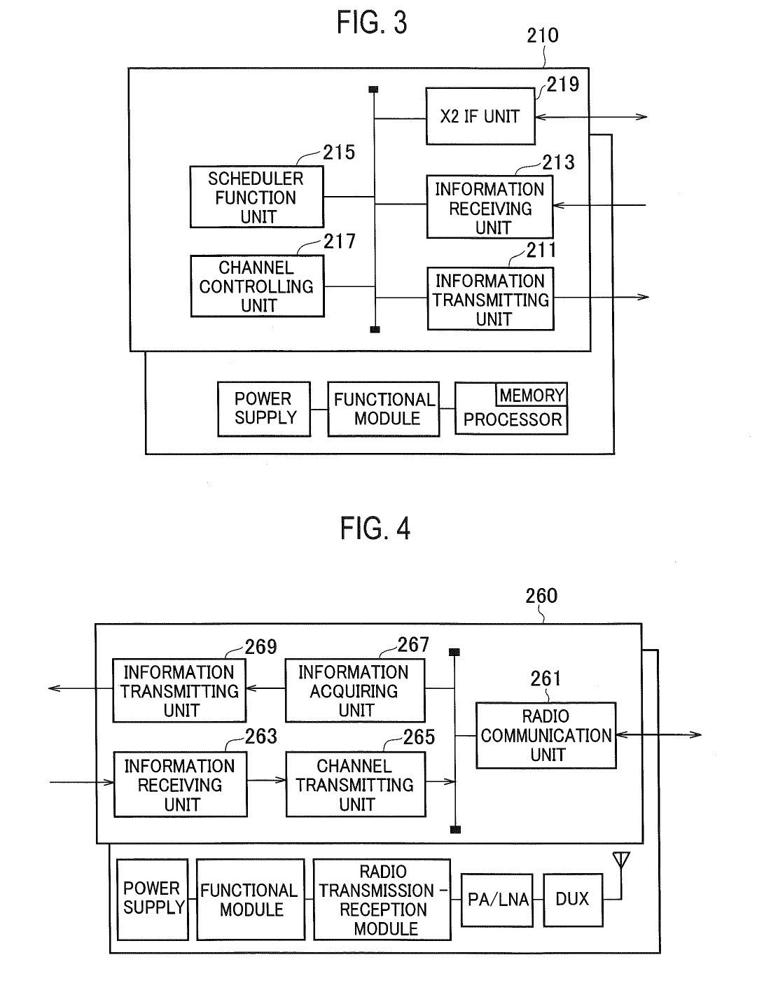

FIG. 3 is a functional block diagram of the central aggregation device 210. As shown in FIG. 3, the central aggregation device 210 includes an information transmitting unit 211, an information receiving unit 213, a scheduler function unit 215, a channel controlling unit 217, and X2 IF unit 219.

As shown in FIG. 3, each functional block of the central aggregation device 210 is implemented by hardware elements such as a processor (including a memory), a functional module (external connection IF and the like) and a power supply.

The information transmitting unit 211 transmits to the remote device 260 information required to perform radio communication with the radio base station 100, specifically, between the remote device 260 and the user device 300. Particularly, in the present embodiment, the information transmitting unit 211 transmits to the remote device 260 a frame containing each of assignment information indicating radio resource assignment used for the radio communication and downlink data that is data (e.g., user data) transmitted to the user device 300. In the present embodiment, the information transmitting unit 211 constitutes a frame transmitting unit.

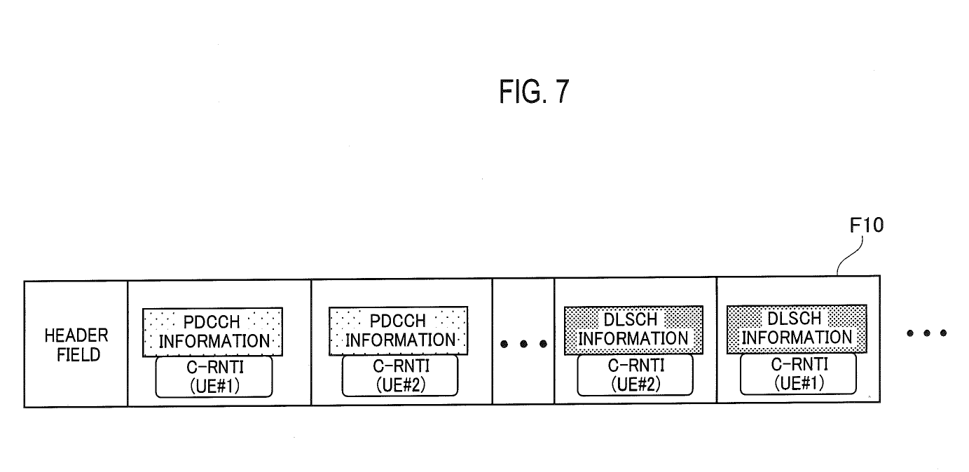

Specifically, based on a notice and the like from the channel controlling unit 217, the information transmitting unit 211 can sequentially transmit frames F10, F20, F30 having configurations shown in FIGS. 7 to 9 to the remote device 260 depending on generation of the assignment information and the downlink data.

A frame is a framework of a predetermined length on a time axis, and it is used for transmitting data such as various control information (including the radio resource assignment information) and the user data. Such a frame may be called a subframe, a slot, merely a signal, and the like.

The assignment information is information indicating a position of a radio resource block (frequency, time, and the like) assigned to the user device 300 for which the scheduler function unit 215 performed the scheduling. The assignment information may be called DCI (Downlink Control Information). The assignment information is transmitted to the user device 300 via a downlink control channel, specifically, the PDCCH (Physical Downlink Control Channel) that is the physical channel in the downlink direction. The assignment information contained in the frame can be information in itself and actually transmitted to the user device 300 via the PDCCH, or can be a part or all of the DCI.

The downlink data is data transmitted via the downlink shared channel, specifically, the DLSCH (Downlink Shared Channel) that is a transport channel in the downlink direction. The downlink data typically includes user data and the like; however, the data included is not necessarily limited to the user data.

The information transmitting unit 211 transmits a frame having a configuration that shows a correspondence between the assignment information and the downlink data. Specifically, the frame has a configuration that allows determination of a reception side, that is, that allows the remote device 260 to determine the downlink data (DLSCH information) that is mapped with the assignment information (PDCCH information). The configuration that allows the determination can be a configuration that explicitly shows the correspondence, or can be a configuration that implicitly shows the correspondence.

More specifically, the information transmitting unit 211 can transmit a frame in which is assigned, to the assignment information and the downlink data, a user identifier for identifying a corresponding user device 300. For example, C-RNTI (Cell-Radio Network Temporary Identity), IMSI (International Mobile Subscriber Identity), and MEI (International Mobile Equipment Identity) can be listed as such a user identifier.

Moreover, the information transmitting unit 211 can transmit a frame in which is assigned, to the assignment information and the downlink data, an index for identifying a combination of the assignment information and the downlink data. Specifically, an index (a number, a character, and the like) that is mapped with the corresponding assignment information is allocated to each downlink data in a frame.

It is preferable that the information transmitting unit 211 constructs a frame in which the assignment information is assigned before the downlink data in the frame, and transmits the frame to the remote device 260.

As mentioned above, the information transmitting unit 211 can construct a frame that explicitly shows a correspondence between the assignment information and the downlink data. However, as explained below, the correspondence can be implicitly shown based on the configuration of the frame.

Specifically, the information transmitting unit 211 transmits a frame in which the assignment information and the downlink data are arranged at predetermined positions of the frame determined based on a predetermined arrangement rule. That is, the information transmitting unit 211 can implicitly show which assignment information is mapped to which downlink data by allocating certain regularity to an order (position) in which the assignment information (PDCCH information) is to be notified and an order in which the downlink data (DLSCH information) is to be notified.

Furthermore, when assigning the downlink data that is mapped with the assignment information over a plurality of the frames, the information transmitting unit 211 can transmit a frame containing position information indicating a position of the downlink data assigned to a frame that is different from the frame to which the assignment information has been assigned, that is, a frame containing a timing.

Such position information is necessary when the PDCCH and the PDSCH (Physical Downlink Shared Channel) that is a physical channel corresponding to the DLSCH are transmitted in different frames (specifically, subframes). Conventionally (until LTE Rel-12), the PDCCH and the PDSCH are transmitted in the same subframe. However, in Narrow Band IoT (LTE Rel-13), a control (Cross subframe scheduling) has been introduced whereby the PDCCH and the PDSCH corresponding to the PDCCH are transmitted in different subframes. Accordingly, it is necessary that even in this case it is possible to determine the correspondence between the assignment information and the downlink data.

Specifically, the information transmitting unit 211 can show as the position information an absolute time-position of the downlink data by using H-SFN (System Frame Number), SFN, and a number of Subframe. Alternatively, the information transmitting unit 211 can show as the position information a relative time-position (in this case, it is assumed that the assignment information is transmitted before the downlink data) from the position of the assignment information (PDCCH information).

Alternatively, the information transmitting unit 211 can show the position information of the downlink data in a plurality of the frames by extending to other frames the range to which the above index is applied. That is, when assigning the downlink data that is mapped with the assignment information over a plurality of the frames, the information transmitting unit 211 transmits the frame in which an index that is common to the plurality of the frames is assigned.

A concrete configuration of a frame transmitted by the information transmitting unit 211 will be explained later.

The information receiving unit 213 receives the information transmitted from the remote device 260. For example, the information receiving unit 213 receives downlink quality information such as CQI (Channel Quality Indicator), PMI (Precoding Matrix Indicator), RI (Rank Indicator), and the like. Moreover, the information receiving unit 213 receives a judgment result of CSI (Channel State Information) and SRS (Sounding Reference Signal), a random access response (RAR), a scheduling request in the downlink direction, and the like.

The scheduler function unit 215 performs scheduling (MAC scheduler and the like) of the radio resource to the user device 300 depending on a status of the plurality of the user devices 300 connected to the radio base station 200, a scheduling request from each of the user devices 300, and the like. The scheduler function unit 215 notifies the channel controlling unit 217 of the result of the scheduling.

The channel controlling unit 217 performs a control of the various channels, specifically, a logical channel, a transport channel, and the physical channel, transmitted and received between the radio base station 100 (specifically, the remote device 260) and the user device 300.

For example, the channel controlling unit 217 determines a transmission timing and contents of the PDCCH, the PDSCH, PHICH (Physical HARQ Indicator Channel), PCFICH (Physical Control Format Indicator Channel), and the like as the physical channel in the downlink direction. Moreover, the channel controlling unit 217 determines a transmission timing and contents of the DLSCH, BCH (Broadcast Channel), PCH (Paging Channel), and the like as the transport channel in the downlink direction.

For example, the channel controlling unit 217 performs a control related to reception of PUCCH (Physical Uplink Control Channel), the SRS (Sounding Reference Signal), PRACH (Physical Random Access Channel), PUSCH (Physical Uplink Shared Channel), and the like as the physical channel in the uplink direction.

The channel controlling unit 217 notifies the information transmitting unit 211 of the contents of the control of the various channels.

The X2 IF unit 219 provides an interface for realizing communication with the central aggregation device 110. Specifically, the X2 IF unit 219 is an interface that directly connects the central aggregation device 110 and the central aggregation device 210 by using the MAC and the RLC. It is preferable that the X2 IF unit 219 is an existing open interface. Data transmitted and received by the user device 300 is relayed to the radio base station 100 via the X2 IF unit 219.

(2.2) Remote Device 260

FIG. 4 is a functional block diagram of the remote device 260. As shown in FIG. 4, the remote device 260 includes a radio communication unit 261, an information receiving unit 263, a channel transmitting unit 265, an information acquiring unit 267, and an information transmitting unit 269.

As shown in FIG. 4, each functional block of the remote device 260 is implemented by hardware elements such as a duplexer, the PA (Power Amplifier)/LNA (Low Noise Amplifier), a radio transmission-reception module (RF conversion), a functional module (quadrature modulation and demodulation and the like) and a power supply.

The radio communication unit 261 performs radio communication with the user device 300. Specifically, the radio communication unit 261 performs the radio communication with the user device 300 according to the specification of the 5G. As mentioned earlier, the radio communication unit 261 can support the Massive MIMO, the carrier aggregation (CA), the dual connectivity (DC), and the like.

The information receiving unit 263 receives the information transmitted from the central aggregation device 210. Specifically, the information receiving unit 263 receives information that is required for the radio communication and transmitted from the central aggregation device 210.

Particularly, in the present embodiment, the information receiving unit 263 receives a frame containing the assignment information indicating the assignment of the radio resource and the downlink data transmitted to the user device 300. In the present embodiment, the information receiving unit 263 constitutes a frame receiving unit.

The channel transmitting unit 265 transmits various channels, specifically, a transport channel in the downlink direction, a physical channel, and the like, to the user device 300.

More specifically, based on the frame received by the information receiving unit 263, the channel transmitting unit 265 transmits the assignment information to the user device 300 via the downlink control channel (specifically, the PDCCH), and transmits the downlink data to the user device 300 via the downlink shared channel (specifically, the DLSCH). As mentioned above, the DLSCH, which is the transport channel, is mapped with the PDSCH, which is the physical channel in the downlink direction.

The information acquiring unit 267 acquires the downlink quality information (CQI and the like), the scheduling request in the downlink direction, and the like, transmitted from the user device 300.

The information transmitting unit 269 transmits to the central aggregation device 210 the downlink quality information, the scheduling request in the downlink direction, and the like, acquired by the channel transmitting unit 265.

(3) Operation of Radio Communication System

An operation of the radio communication system 10 is explained below. Specifically, the operation performed by the remote device 260 when transmitting the downlink control channel and the downlink shared channel based on the frame transmitted from the central aggregation device 210 to the remote device 260 is explained.

(3.1) Outline of Operation

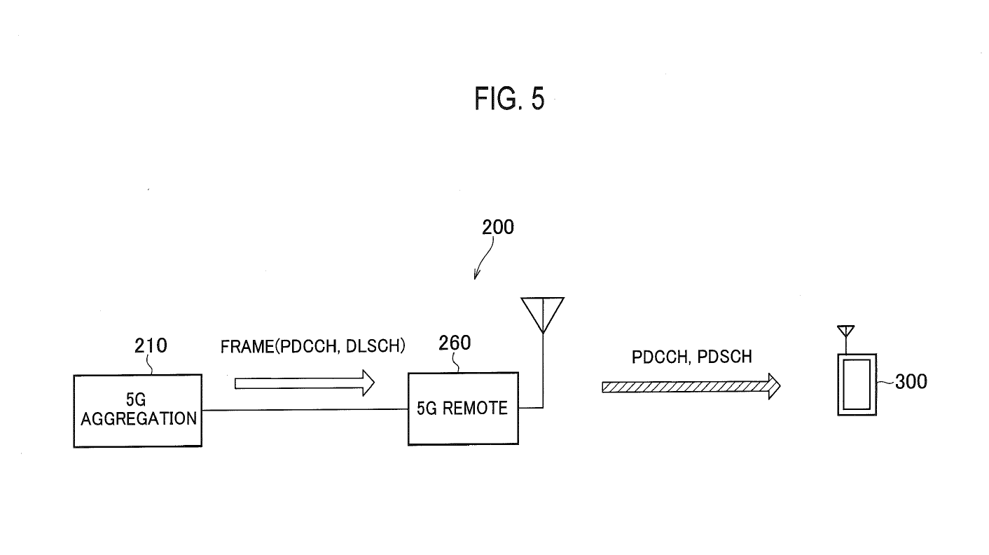

FIG. 5 is a conceptual diagram of a transmission operation of a downlink control channel (PDCCH) and a downlink shared channel (PDSCH) performed by the central aggregation device 210, the remote device 260, and the user device 300.

As shown in FIG. 5, a frame transmitted from the central aggregation device 210 to the remote device 260 contains the assignment information (PDCCH information) and the downlink data (DLSCH information). The central aggregation device 210 sequentially transmits such frames to the remote device 260.

The remote device 260 generates the PDCCH based on the contents of the received frame, that is, the assignment information (PDCCH information), and transmits the same to the user device 300. Moreover, based on the downlink data (DLSCH information) the remote device 260 generates the PDSCH corresponding to the DLSCH, and transmits the same to the user device 300.

(3.2) Channel Transmission Sequence

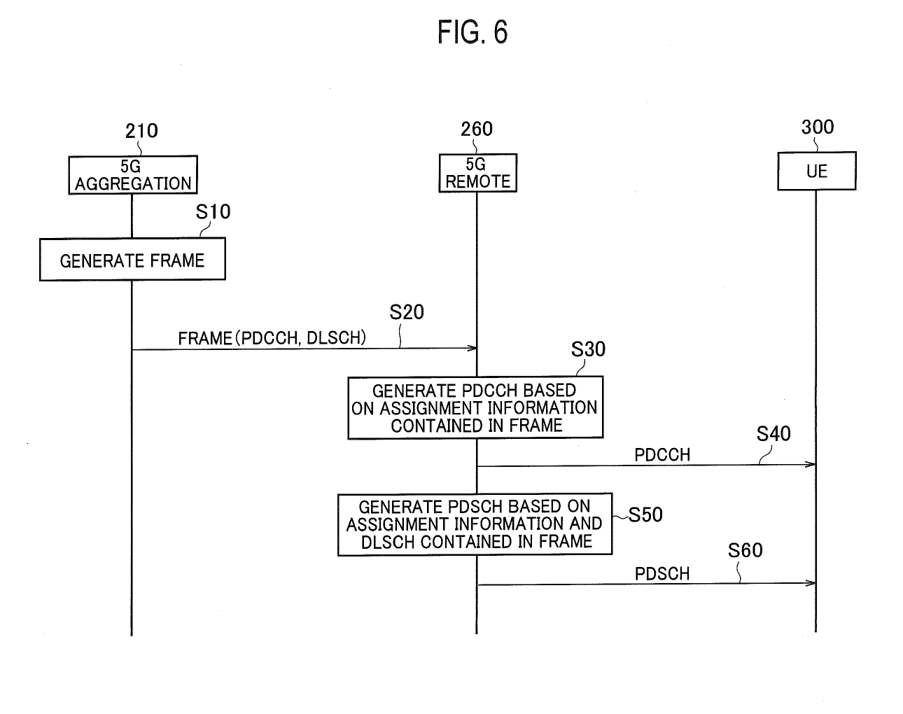

FIG. 6 depicts a channel transmission sequence based on a frame transmitted from the central aggregation device 210. As shown in FIG. 6, the central aggregation device 210 generates a frame containing the assignment information (PDCCH information) and the downlink data (DLSCH information) (S10).

Subsequently, the central aggregation device 210 transmits the generated frame (containing the PDCCH information and the DLSCH information) to the remote device 260 (S20).

The remote device 260 generates the PDCCH based on the assignment information contained in the received frame (S30). Subsequently, the remote device 260 transmits the generated PDCCH to the user device 300 (S40).

Moreover, the remote device 260 generates the PDSCH based on the assignment information and the downlink data (DLSCH information) contained in the received frame (S50). Subsequently, the remote device 260 transmits the generated PDSCH to the user device 300 (S60).

The generation and transmission timings (S30, S40) of the PDCCH and the generation and transmission timings (S50, S60) of the PDSCH shown in FIG. 6 can be interchanged.

(3.3) Example of Frame Configuration

A configuration example of a frame transmitted from the central aggregation device 210 is explained below. FIG. 7 is a configuration example (1) of the frame.

As shown in FIG. 7, the frame F10 contains a header field, a plurality of assignment information (PDCCH information), and a plurality of downlink data (DLSCH information). Each PDCCH information has a user identifier (C-RNTI) for uniquely identifying the user device 300. Similarly, each DLSCH information also has a user identifier (C-RNTI).

That is, the PDCCH information and the DLSCH information are mapped with each other by the same C-RNTI (e.g., UE#1). As a result, the remote device 260 that received the frame F10 can determine which DLSCH information corresponds to which PDCCH information.

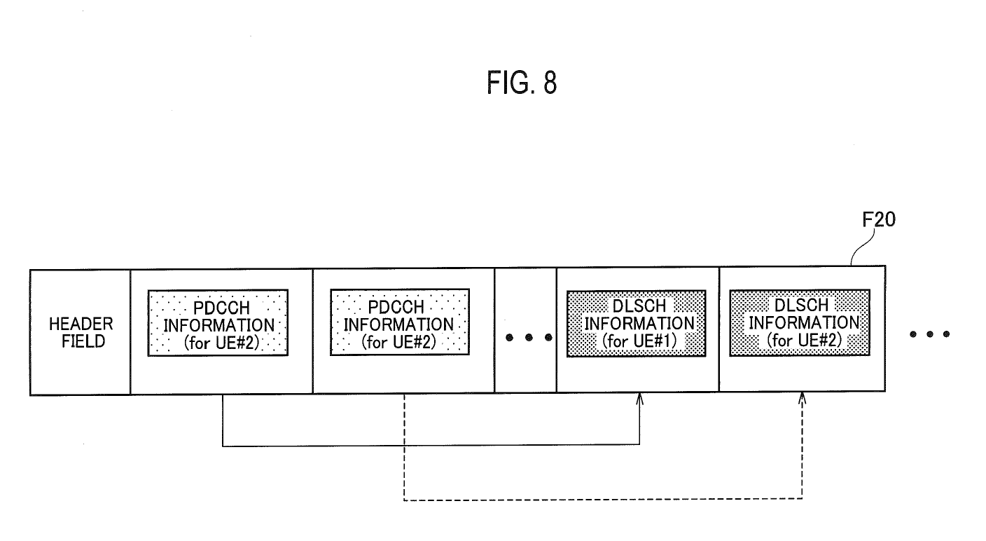

FIG. 8 is a configuration example (2) of the frame. As shown in FIG. 8, the frame F20 also contains a plurality of assignment information (PDCCH information) and a plurality of downlink data (DLSCH information).

The frame F20 is an example that implicitly indicates the correspondence between the PDCCH information and the DLSCH information based on the configuration of the frame. In contrast to the frame F10, the PDCCH information and the DLSCH information in the frame F20 do not have a user identifier. In the frame F20, the positions of the PDCCH information and the DLSCH information in the frame, that is, a transmission order, are established based on a predetermined arrangement rule. As a result, the remote device 260 that received the frame F20 can determine which DLSCH information corresponds to which PDCCH information.

In the configuration example shown in FIG. 8, the PDCCH information is arranged (that is, transmitted) in order from the information for a user device #1 (UE#1). After the PDCCH information, the DLSCH information (see arrows) corresponding to the PDCCH information for the user device (UE#1, UE#2, . . . ) is arranged (transmitted) in the same order as the order which the PDCCH information is arranged.

In the frame F20, the PDCCH information and the DLSCH information are simply arranged sequentially. However, as far as the information is arranged based on a predetermined arrangement rule and the remote device 260 can recognize that arrangement rule, the arrangement order of one or both the PDCCH information and the DLSCH information can be changed (e.g., not in the ascending order, but in a descending order).

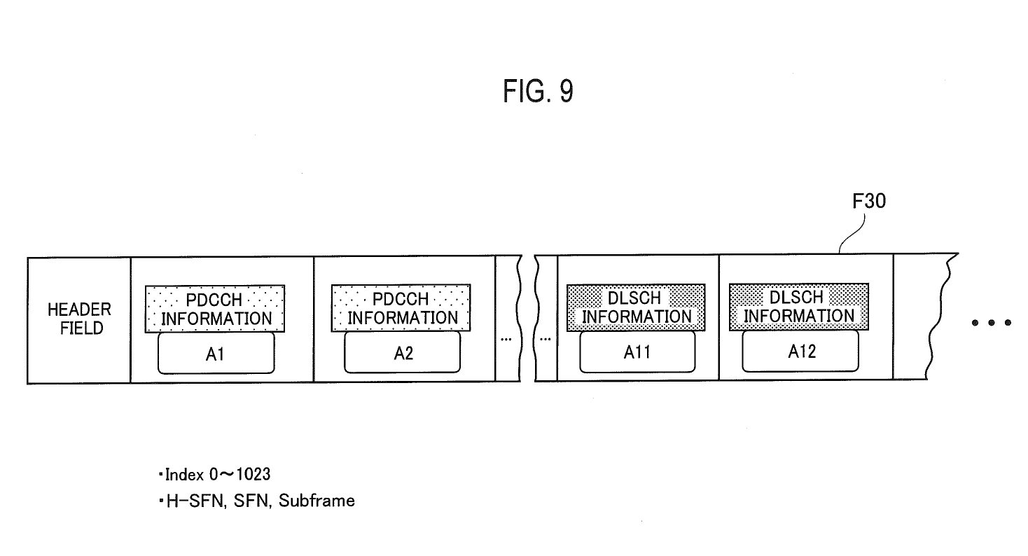

FIG. 9 is a configuration example (3) of the frame. As shown in FIG. 9, the PDCCH information and the DLSCH information in the frame F30 have areas A1, A2, A11, A12 indicating position information (frame position) of an index or the DLSCH information.

If the index is used, e.g., a range thereof is defined as 0 to 1023 (10 bits), and the central aggregation device 210 increments the value depending on a transmission order of the DLSCH information and that value is shown in the areas A11, A12 of the DLSCH information. Moreover, the central aggregation device 210 allocates the same value of the index to the PDCCH information corresponding to the DLSCH information.

As mentioned above, the position information of the downlink data in a plurality of frames can be shown by extending to other frames the range to which the above index is applied. That is, the values of the index of the DLSCH information corresponding to the PDCCH information are shown over a plurality of the frame.

Moreover, when the frame position is used, as shown in FIG. 9, when transmitting the PDCCH information, the H-SFN (System Frame Number), the SFN, the number of the Subframe indicating the position where the corresponding DLSCH information is arranged are shown in areas A1, A2 of the PDCCH information. As a result, the remote device 260 can determine the DLSCH information corresponding to the PDCCH information.

(4) Effects and Advantages

According to the present embodiment, the following effects and advantages can be obtained. Specifically, the central aggregation device 210 (information transmitting unit 211) transmits a frame having a configuration that shows a correspondence between the assignment information (PDCCH information) and the downlink data (DLSCH information). Moreover, the remote device 260 (channel transmitting unit 265) sets the downlink control channel (PDCCH) and the downlink shared channel (DLSCH, PDSCH) based on this correspondence.

Therefore, the remote device 260 can identify the radio resource assignment information to be used for transmitting the downlink data and can correctly transmit the downlink data to the user device 300.

That is, the remote device 260 can correctly transmit the downlink data based on the radio resource assignment information from the central aggregation device 210 even when a function of an upper layer such as the MAC scheduler and a function of a radio physical layer are mounted separately.

In the present embodiment, as in the frame F10, the central aggregation device 210 can transmit a frame to which the user identifier has been assigned. Therefore, the remote device 260 can quickly and easily determine a correspondence between the assignment information (PDCCH information) and the downlink data (DLSCH information) by referring to the user identifier.

Moreover, as in the frame F20, the central aggregation device 210 can transmit a frame in which the assignment information (PDCCH information) and the downlink data (DLSCH information) are arranged at a predetermined position of the frame determined based on a predetermined arrangement rule. Therefore, the remote device 260 can determine the correspondence without there being an increase in the amount of information for showing the user identifier.

Furthermore, as in the frame F30, the central aggregation device 210 can transmit a frame in which an index that identifies a combination of the assignment information (PDCCH information) and the downlink data (DLSCH information) is assigned, or a frame containing a frame position (position information) of the downlink data (DLSCH information).

Therefore, the remote device 260 can quickly and easily determine the correspondence, and particularly, the correspondence can be determined surely even when the downlink data, which is mapped with the assignment information, is assigned over a plurality of the frames.

Moreover, in the present embodiment, the central aggregation device 210 transmits a frame in which the assignment information is assigned before the downlink data in the frame. Therefore, the remote device 260 can prioritize the transmission of the PDCCH over the DLSCH (PDSCH), and the user device 300 can quickly prepare for the reception of the PDSCH.

(5) Other Embodiments

The present invention has been explained in detail by using the above embodiments; however, it is self-evident to a person skilled in the art that the present invention is not limited to the embodiments explained herein and that the embodiments can be modified or improved in various ways.

For example, the above embodiments are explained by taking a correspondence between the PDCCH and the DLSCH as an example; however, the present invention is applicable as well to a correspondence between other downlink control channels and downlink shared channels. In this case, the PCFICH, the PHICH, and the like can be listed as the downlink control channels. Moreover, the PDSCH and the like can be listed as the downlink shared channels.

Moreover, in the above embodiments, a radio communication system having a configuration that is right after the 5G was introduced is assumed, and the LTE assisted operation in which the 5G assists the 4G is realized. However, the present invention is applicable not only to such LTE assisted operation but also, for example, to operation in the 5G alone.

Furthermore, though an explanation has been given in the above embodiments by using the terms prescribed in the 3GPP mainly, these terms can be replaced with some other terms. For example, as also mentioned in the above embodiments, the user device can be called a radio communication terminal, a mobile station, a user terminal, and the like. Moreover, the radio base station can be called a node, a radio communication device or system, and the like.

The sequences, flowcharts, and the like in the embodiments described above may be rearranged in order unless it causes a contradiction.

Note that the terms used in the descriptions of this specification and/or terms necessary to understand this specification may be replaced with terms having the same or similar meanings. For example, a channel and/or a symbol may be a signal, or a signal may be a message. In addition, the terms “system” and “network” may be used interchangeably.

Moreover, the above-described parameters and the like may be expressed by absolute values, by relative values from specified values, or by other associated information. For example, radio resources may be instructed by an index.

The radio base stations (the radio base stations 100 and 200, hereinafter referred as a base station) can accommodate one or more (for example, three) cells (also called sectors). When a base station has multiple cells, the entire coverage area of the base station can be divided into multiple smaller areas.

The term “cell” or “sector” means part or the whole of the coverage area provided by a base station and/or a subsystem of the base station that provide communication services in this coverage. Further, the terms “base station”, “eNB”, “cell”, and “sector” can be used interchangeably in this specification. In some cases, a base station (BS) is also called terms such as a fixed station, a NodeB, an eNodeB (eNB), an access point, a femtocell, and a small cell.

The UE 300 is also called in some cases by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

“The expression “based on” used in this specification does not mean “based only on” unless explicitly stated otherwise. In other words, the expression “based on” means both “based only on” and “based at least on”.

In addition, the terms “including”, “comprising”, and other variations thereof are intended to be comprehensive as with “comprise”. Moreover, the term “or” used in this specification or the scope of claims is intended not to be exclusive disjunction.

Any reference of the elements using names such as “first”, “second”, and the like used in this specification does not limit the amount or the order of these elements in general. These names can be used in this specification as a convenient way of discriminating two or more elements. Thus, referring to a first element and a second element does not mean that only the two elements can be employed in the specification or that the first element should precede the second element in some form.

In the entirety of this specification, for example, when articles such as a, an, and the in English are added in translation, these articles also mean to include plurality as long as the context does not clearly indicate the singularity.

The present invention can be expressed as below. A radio base station (radio base station 100) according to one aspect of the present invention includes a remote device (remote device 260) and a central aggregation device (central aggregation device 210) and performs radio communication with a user device (user device 300), wherein the central aggregation device includes a frame transmitting unit (information transmitting unit 211) that transmits to the remote device a frame (for example, frame F10) containing each of assignment information indicating radio resource assignment and downlink data that is data transmitted to the user device, and the remote device includes a frame receiving unit (information receiving unit 263) that receives the frame; and a channel transmitting unit (channel transmitting unit 265) that, based on the frame received by the frame receiving unit, transmits the assignment information to the user device via a downlink control channel (PDCCH) and transmits the downlink data to the user device via a downlink shared channel (DLSCH), wherein the frame transmitting unit transmits the frame having a configuration indicating a correspondence between the assignment information and the downlink data, and the channel transmitting unit sets the downlink control channel and the downlink shared channel based on the correspondence.

In the above aspect of the present invention, the frame transmitting unit can transmit the frame in which is assigned, to the assignment information and the downlink data, a user identifier for identifying a corresponding user device.

In the above aspect of the present invention, the frame transmitting unit can transmit the frame in which is assigned, to the assignment information and the downlink data, an index for identifying a combination of the assignment information and the downlink data.

In the above aspect of the present invention, the frame transmitting unit can transmit the frame in which the assignment information and the downlink data are arranged at predetermined positions of the frame determined based on a predetermined arrangement rule.

In the above aspect of the present invention, the frame transmitting unit can transmit, when assigning the downlink data that is mapped with the assignment information over a plurality of the frames, the frame containing position information indicating a position of the downlink data assigned to other frame.

In the above aspect of the present invention, the frame transmitting unit can transmit, when assigning the downlink data that is mapped with the assignment information over a plurality of the frames, the frame in which is assigned the index that is common to the plurality of the frames.

In the above aspect of the present invention, the frame transmitting unit can transmit the frame in which the assignment information is assigned before the downlink data in the frame.

A communication control method according to another aspect of the present invention is implemented in a radio base station including a remote device and a central aggregation device and that performs radio communication with a user device, the communication control method includes transmitting including the central aggregation device transmitting to the remote device a frame containing each of assignment information indicating radio resource assignment and downlink data that is data transmitted to the user device; and transmitting including the remote device, based on the received frame, transmitting the assignment information to the user device via a downlink control channel and transmitting the downlink data to the user device via a downlink shared channel, wherein the transmitting the frame to the remote device includes transmitting the frame having a configuration indicating a correspondence between the assignment information and the downlink data, and the transmitting the downlink data to the user device includes setting the downlink control channel and the downlink shared channel based on the correspondence.

As described above, the details of the present invention have been disclosed by using the embodiment of the present invention. However, the description and drawings which constitute part of this disclosure should not be interpreted so as to limit the present invention. From this disclosure, various alternative embodiments, examples, and operation techniques will be apparent to a person skilled in the art.

The entire contents of Japanese Patent Application 2016-078455 (filed on Apr. 8, 2016) are incorporated in the description of the present application by reference.

### INDUSTRIAL APPLICABILITY

According to the above radio base station and the communication control method, the remote device can correctly transmit the downlink data based on the radio resource assignment information from the central aggregation device even when the function of the upper layer such as the MAC scheduler and the function of the radio physical layer are mounted separately.

### EXPLANATION OF REFERENCE NUMERALS

10 radio communication system
20 core network
100 radio base station
110 central aggregation device
160 remote device
200 radio base station
210 central aggregation device
211 information transmitting unit
213 information receiving unit
215 scheduler function unit
217 channel controlling unit
219 X2 IF unit
260 remote device
261 radio communication unit
263 information receiving unit
265 channel transmitting unit
267 information acquiring unit
269 information transmitting unit
F10, F20, F30 frame

1. A radio base station including a remote device and a central aggregation device and that performs radio communication with a user device, wherein
the central aggregation device includes a frame transmitting unit that transmits to the remote device a frame containing each of assignment information indicating radio resource assignment and downlink data that is data transmitted to the user device, and
the remote device includes
a frame receiving unit that receives the frame; and
a channel transmitting unit that, based on the frame received by the frame receiving unit, transmits the assignment information to the user device via a downlink control channel and transmits the downlink data to the user device via a downlink shared channel, wherein
the frame transmitting unit transmits the frame having a configuration indicating a correspondence between the assignment information and the downlink data, and
the channel transmitting unit sets the downlink control channel and the downlink shared channel based on the correspondence.

2. The radio base station as claimed in claim 1, wherein the frame transmitting unit transmits the frame in which is assigned, to the assignment information and the downlink data, a user identifier for identifying a corresponding user device.

3. The radio base station as claimed in claim 1, wherein the frame transmitting unit transmits the frame in which is assigned, to the assignment information and the downlink data, an index for identifying a combination of the assignment information and the downlink data.

4. The radio base station as claimed in claim 1, wherein the frame transmitting unit transmits the frame in which the assignment information and the downlink data are arranged at predetermined positions of the frame determined based on a predetermined arrangement rule.

5. The radio base station as claimed in claim 1, wherein the frame transmitting unit transmits, when assigning the downlink data that is mapped with the assignment information over a plurality of the frames, the frame containing position information indicating a position of the downlink data assigned to other frame.

6. The radio base station as claimed in claim 3, wherein the frame transmitting unit transmits, when assigning the downlink data that is mapped with the assignment information over a plurality of the frames, the frame in which is assigned the index that is common to the plurality of the frames.

7. The radio base station as claimed in claim 1, wherein the frame transmitting unit transmits the frame in which the assignment information is assigned before the downlink data in the frame.

8. A communication control method implemented in a radio base station including a remote device and a central aggregation device and that performs radio communication with a user device, the communication control method comprising:
transmitting including the central aggregation device transmitting to the remote device a frame containing each of assignment information indicating radio resource assignment and downlink data that is data transmitted to the user device; and
transmitting including the remote device, based on the received frame, transmitting the assignment information to the user device via a downlink control channel and transmitting the downlink data to the user device via a downlink shared channel, wherein
the transmitting the frame to the remote device includes transmitting the frame having a configuration indicating a correspondence between the assignment information and the downlink data, and
the transmitting the downlink data to the user device includes setting the downlink control channel and the downlink shared channel based on the correspondence.
